(19) United States
(12) Patent Application Publication
(10) Pub. No.: US 2003/0164837 A1
(43) Pub. Date: Sep. 4, 2003

(54) Processing method for attribute information of data stream and apparatus thereof

(76) Inventor: Jae Yoon Jeong, Seoul (KR)

Correspondence Address: BIRCH STEWART KOLASCH & BIRCH, PO BOX 747, FALLS CHURCH, VA, 22040-0747, US

(21) Appl. No.: 10/308,110

(22) Filed: Dec. 3, 2002

(30) Foreign Application Priority Data
Dec. 3, 2001 (KR) 2001-0075809

(51) Int. Cl. G09G 5/00

(52) U.S. Cl. 345/581

(57) ABSTRACT

The present invention is related to a processing method for attribute information of a data stream and an apparatus thereof, in which display attributes of the data stream such as a location, a size, and a shape of a window are altered by an image output apparatus, thereby displaying images without overlapping one another. To achieve this object, the method for attribute information of a data stream comprises the steps of determining whether the display attribute of the data stream requires an alteration or not; if the display attribute requires the alteration, generating a command frame having attribute information of display attributes to be altered; and transmitting the data stream and the command frame through a transmittance means.

### BACKGROUND OF THE INVENTION

1. Field of the Invention

The present invention relates to a processing method for attribute information of a data stream and an apparatus thereof, and more particularly, to a method for processing display attribute information such as a location, a size of an image, and a shape of a window and apparatus thereof.

2. Description of the Background Art

Recently, as electronics technology is developed, various interface techniques which connect various kinds of digital appliances on network and control operations reciprocally are being developed and used.

FIG. 1 is a construction view showing a digital image system in accordance with the conventional art As shown, the system comprises: a digital image output device 100 such as a video tape recorder (VTR), a digital versatile disc (DVD) player, or a set top box for receiving or replaying a predetermined image data and then displaying it through a predetermined path; and a digital image display device 110 such as a digital television receiver or a plasma display panel (PDP) television receiver for receiving a predetermined data stream transmitted from the image output device 100 and image processing, thereby displaying the received image on a screen. At this time, the digital image output device 100 and the digital image display device 110 are connected to each other by an interface cable 120 based on Institute of Electrical and Electronics Engineers (IEEE) 1394 interface technique.

The digital image output device 100 and the digital image display device 110 interconnected by the interface cable 120 generate an Audio Video/Control (AV/C) command frame reciprocally and transmit by the interface cable 120, thereby controlling each image. Then, if commands of the command frame are performed, the digital image output device and the digital image display device 100 and 110 generate a result of the command performance as an AV/C response frame, thereby transmitting reciprocally through the interface cable 120.

FIG. 2 is a structure showing an AV/C command frame of a general IEEE 1394. As shown, the AV/C command frame is composed of plural lines, and each line is composed of 32 bits.

More specifically speaking, the AV/C command frame includes: ‘0000’ of 4 bits indicating a command; ‘ctype’ of 4 bits indicating a command for a predetermined operation; ‘subunit-type’ of 5 bits indicating a device to perform a command; ‘subunit-ID’ of 3 bits dividing each performance unit in the device to perform a command; ‘opcode’ of 8 bits indicating a command to perform; and plural ‘operand[0]’˜‘operand[n]’ ( n represents 0, 1, 2, . . . ). Herein, a mode ‘0’ is contained in residual bits next the ‘operand[n]’, so that the last line is also formed with 32 bits.

FIG. 3 is a structure showing an AV/C response frame of a general IEEE 1394. As shown, the AV/C response frame has the same structure with that of the AV/C command frame except that ‘response’ of 4 bits indicating the AV/C response frame is inserted at a next position of ‘0000’ corresponding to a command instruction of 4 bits instead of the ‘ctype’ of 4 bits

As shown in FIG. 4, in the AV/C command frame and the AV/C response frame, the ‘opcode’ of 8 bits includes a predetermined command and ‘opcode’ values corresponding to the command.

Operations of the digital image system will be explained.

The digital image output device 100 transmits a data stream of a predetermined image to the digital image display device 110 through the interface cable 120, and the digital image display device 110 receives the data stream transmitted from the digital image output device 100 through the interface cable 120 and displays on a screen.

At this time, in case of displaying an image of the data stream transmitted from the digital image output device 100 on the screen, the digital image display device 110 displays the image at the entire screen, as shown in FIG. 5.

However, when the digital image output device 100 transmits the data stream to the digital image display device 110 and displays a predetermined image on the screen, there is a case that a size of the image displayed on the screen, a location, and a shape of a window should be altered by altering display attribute of the data stream. For example, in case that the digital image output device 100 generates a predetermined ‘on screen display’ (OSD), transmits the generated OSD screen to the digital image display device 110 with a predetermined data stream of the image, and displays on the screen, the OSD and the image of the data stream are overlapped each other. Accordingly, since a user can not recognize the image and the OSD accurately, the display attribute of the data stream has to be altered so that a location of the image and a location of the OSD can not be overlapped each other on the screen.

However, the conventional digital image display device 110 only displays the data stream of the image inputted from the digital image output device 100 on the entire screen and does not control a location of the image on the screen, a size, and a shape of a window by altering the display attribute of the data stream by the image output device 100.

Also, in the conventional digital image display device 110, even though the image of the data stream inputted from the digital image output device 100 is displayed as a partial screen by the user's fabrication and the display location can be moved, the case is possible only when the user controls by watching the screen and it is impossible to control a location of the image on the screen, a size, and a shape of a window by altering the display attribute of the data stream by the image output device 100.

### SUMMARY OF THE INVENTION

An object of the present invention is to provide a method for preventing images from being overlapped to each other and an apparatus thereof, in which a size of an image displayed on a screen, a location, and a shape of a window are controlled by altering attributes of a data stream which is displayed by being transmitted from a digital image output device to a digital image display device by the image output device

An another object of the present invention is to provide a method for variously controlling a replay screen of the digital image display device by an intention of a transmitting side if necessary and an apparatus thereof.

To achieve these and other advantages and in accordance with the purpose of the present invention, as embodied and broadly described herein, there is provided a processing method for attribute information of a data stream comprising the steps of: determining whether a display attribute of a data stream requires an alteration or not; if the display attribute requires the alteration, generating a command frame having attribute information of a display attribute to be altered; and transmitting the data stream and the command frame through a transmittance means.

To further achieve these and other advantages and in accordance with the purpose of the present invention, a processing apparatus for attribute information of a data stream comprising: a data stream output unit for generating a data stream of an image to be displayed on a screen; and an image output control unit for controlling a generation of the data stream from the data stream output unit and generating a command frame having attribute information by which the display attribute of the data stream is altered.

The foregoing and other objects, features, aspects and advantages of the Is present invention will become more -apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a construction view showing a digital image system in accordance with the conventional art;

FIG. 2 is a structure showing an AV/C command frame of a general IEEE 1394;

FIG. 3 is a structure showing an AV/C response frame of a general IEEE 1394;

FIG. 4 is a view showing ‘opcode’ values and command instructions for ‘opcode’ in the AV/C command frame and the AV/C response frame;

FIG. 5 is a view showing that a data stream of the conventional digital image output device is received by a digital image display device and thereby an image is displayed on a screen;

FIG. 6 is a construction view showing a digital image system according to the present invention;

FIGS. 7A and 7B are views to explain the AV/C command frame and a is location where an image of the data stream is displayed on the screen according to the first preferred embodiment of the present invention;

FIGS. 8A and 8B are views to explain the AV/C command frame and a location where the image of the data stream is displayed on the screen according to the second preferred embodiment of the present invention;

FIGS. 9A and 9B are views to explain the AV/C command frame and a location where the image of the data stream is displayed on the screen according to the third preferred embodiment of the present invention;

FIGS. 10A and 10B are views to explain the AV/C command frame and a location where the image of the data stream is displayed on the screen according to the fourth preferred embodiment of the present invention;

FIG. 11 is a view to explain that an attribute division label is inserted into the AV/C command frame according to the present invention; and

FIG. 12 is a view to explain that a stream division label is inserted into the AV/C command frame according to the present invention.

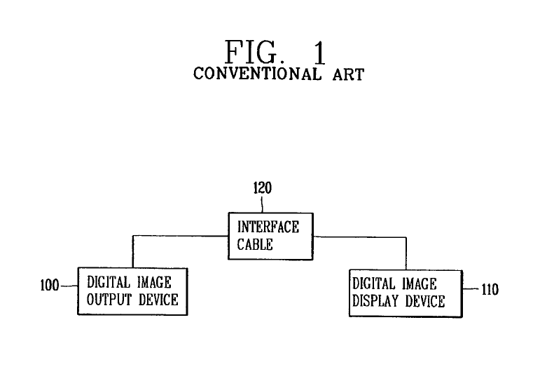

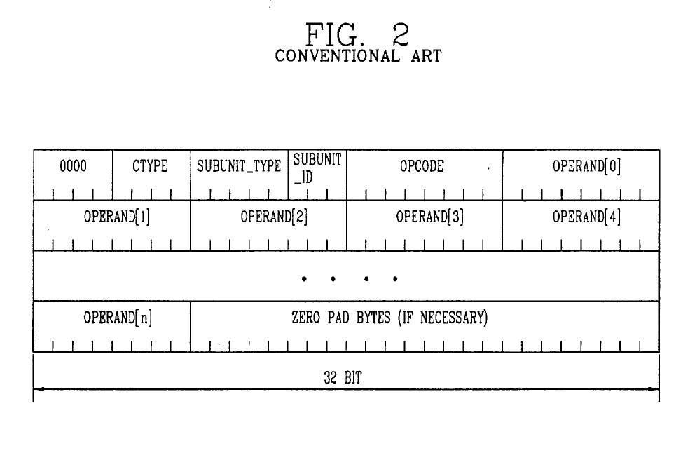

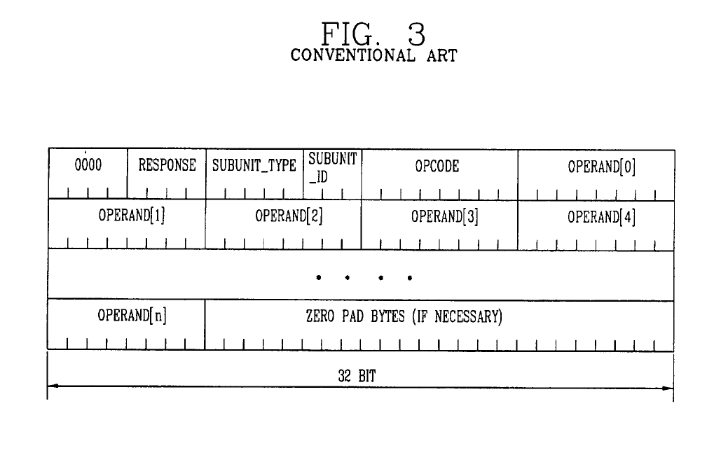

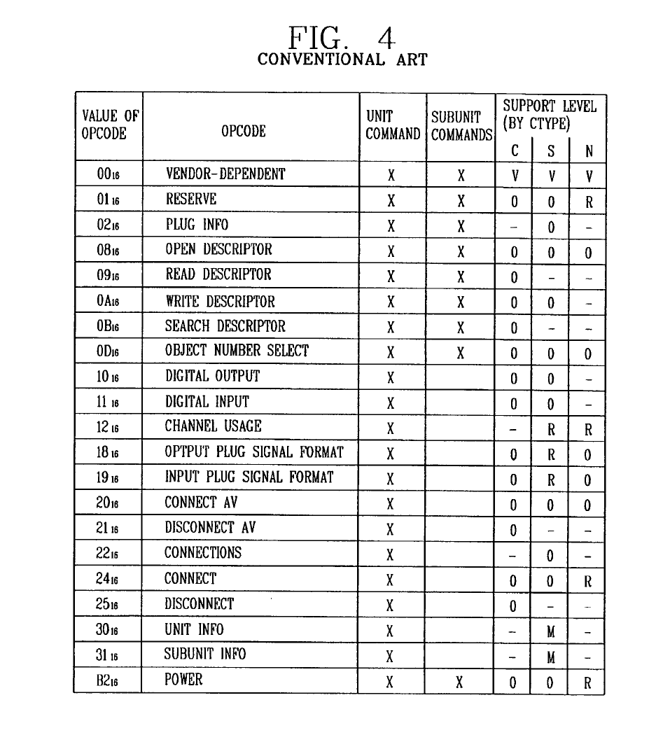

### DETAILED DESCRIPTION OF THE PREFERRED EMBODIMENTS

Reference will now be made in detail to the preferred embodiments of the present invention, examples of which are illustrated in the accompanying drawings.

FIG. 6 is a digital image system according to the present invention. As shown, the system comprises: a digital image output device 200 for receiving or replaying a predetermined image data; and a digital image display device 210 for receiving a predetermined data stream transmitted from the image output device 200 and image processing, thereby displaying the received image on a screen. At this time, the digital image output device 200 and the digital image display device 210 are connected to each other by an interface cable 220 based on Institute of. Electrical and Electronics Engineers (IEEE) 1394 interface technique.

The digital image output device 200 includes: a data stream output unit 201 for generating a data stream of a predetermined image and voice and transmitting the generated data stream to the digital image display device 210 through the interface cable 220; and an image output control unit 203 for controlling an operation of the data stream output unit 201, generating the AV/C command frame having attribute information such as a location where an image of the data stream generated from the data stream output unit 201 is displayed on a screen of the digital image display device 210, a size, and a shape of a window by the attribute information display attribute is altered;, and transmitting the generated AV/C command frame to the digital image display device 210 through the interface cable 220.

Also, the digital image display device 210 includes: a receiving unit 211 for receiving the data stream generated from the digital image output device 200 and transmitted through the interface cable 220 and the AV/C command frame; a video display processor (VDP) 213 for processing the data stream received by the receiving unit 211, outputting, and thereby displaying an image on the screen; and an image display control unit 215 for controlling the VDP 213 according to the attribute information in the AV/C command frame received by the receiving unit 211 and thereby controlling the display attribute of the data stream.

Operations of the digital image system according to the present invention will be explained.

First, the data stream output unit 201 of the digital image output device 200 generates a data stream of a predetermined image and voice, and the generated data stream is transmitted to the digital image display device 210 through the interface cable 220. Then, the data stream is received by the receiving unit 211 of the digital image display device 210, and the data stream received by the receiving unit 211 is processed by the VDP 213, thereby displaying a predetermined image on the screen.

Also, in case that the digital image output device 200 is to alter the display attribute of the data stream such as an output of the OSD, the digital image output control unit 200 generates the AV/C command frame having the attribute information of the display attribute to be altered and transmits the generated AV/C command frame to the digital image display device 210 through the interface cable 220. Then, the receiving unit 211 of the digital image display device 210 receives the AV/C command frame inputted from the digital image output device 200 and inputs to the image display control unit 215. The image display control unit 215 determines the attribute information inputted to the command frame and controls the VDP 213 according to the determined attribute information, thereby altering a location of the image displayed on the screen, a size, and a shape of a window.

At this time, the image output control unit 203 generates the AV/C command frame having the attribute information by which the display attribute of the data frame is altered. Then, the digital image display device 210 alters the display attribute of the data frame according to the attribute information of the AV/C command frame and alters a location of the image displayed on the screen, a size, and a shape of a window, which will be explained in more detail.

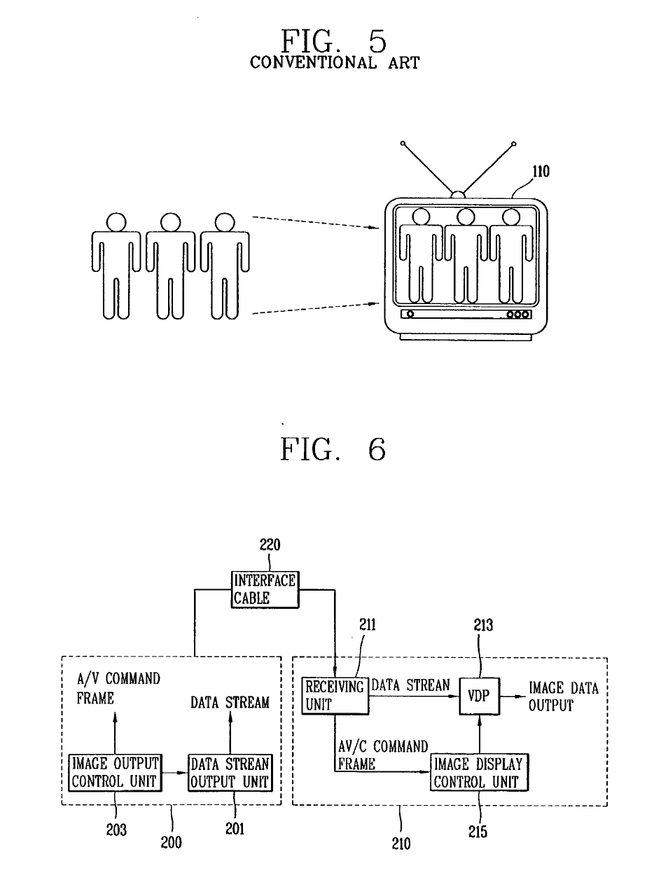

First, in the AV/C command frame, an ‘opcode’ value notifying an alteration of the display attribute of the data stream is set. That is, the ‘opcode’ value of the AV/C command frame is set according to kinds of commands as shown in FIG. 5. In the preferred embodiment of the present invention, one value except the ‘opcode’ value set in FIG. 5 is newly set, and the set value is defined as an attribute alteration command ‘stream resize’ for commanding an alteration of the display attribute of the data stream.

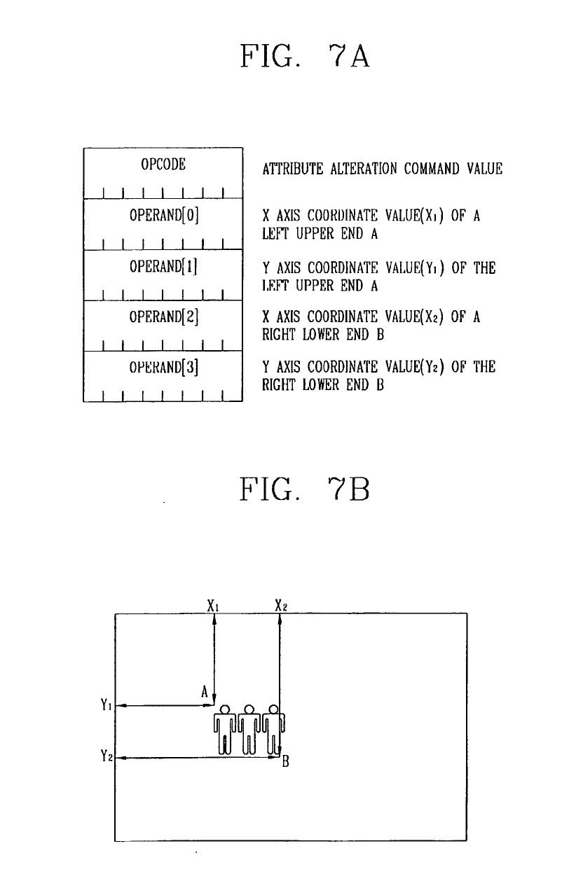

In case that the display attribute of the data stream is altered by generating the command frame by the image output control unit 203 in a state that the attribute alteration command is defined as shown in FIG. 7A, an attribute alteration command value is inserted to the ‘opcode’. Then, attribute information such as coordinate values on the screen, a size of the image, and a height is inserted to the ‘operand[0]˜operand[3]’ corresponding to the next position of the ‘opcode’,

For example, if it is assumed that an image is displayed on the screen of the digital image display device 210 as shown in FIG. 7B, the image output control unit 203 inserts a X axis coordinate value (X1) of a left upper end A into the ‘operand[0]’, a Y axis coordinate value (Y1) of the left upper end A into the ‘operand[1]’, a X axis coordinate value (X2) of a right lower end B into the ‘operand[2]’, and a Y axis coordinate value (Y2) of the right lower end B into the ‘operand[3]’.

Like this, the AV/C command frame having the attribute information such as the attribute alteration command value, the X axis coordinate values, and the Y axis coordinate values is transmitted to the digital image display device 210 through the interface cable 220 and received by the receiving unit 211. The AV/C command frame received by the receiving unit 211 is inputted to the image display control unit 215. Then, the image display control unit 215 determines the display attribute alteration of the data stream by the ‘opcode’ of the AV/C command frame, determines the coordinate values, that is, X1 and Y1 of A, and X2 and Y2 of B, by the display information of the ‘operand[0]˜operand[3]’, and controls the VDP 213 according to the determined coordinate values, thereby displaying an image on the screen as shown in FIG. 7B.

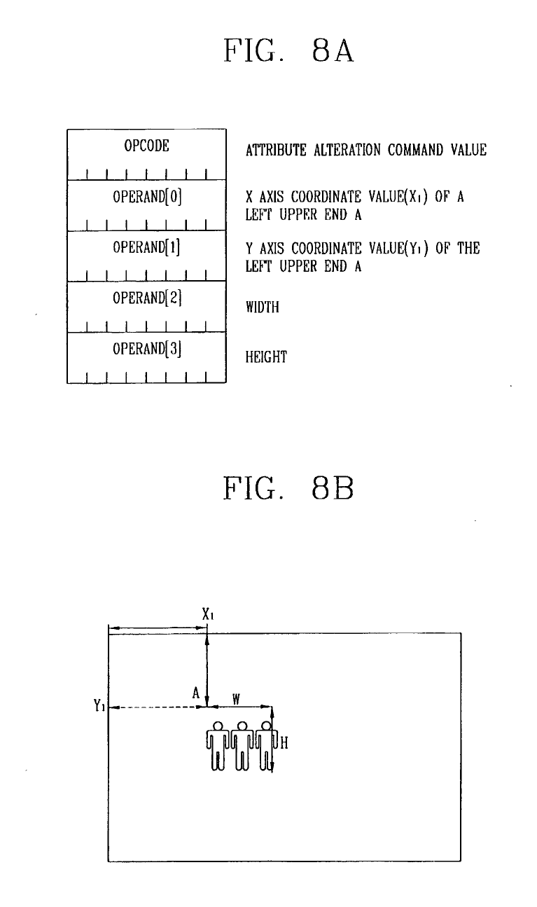

Also, altering the display attribute includes several methods besides the aforementioned method. That is, as shown in FIGS. 8A and 8B, it is also possible that the X axis coordinate value (X1) and the Y axis coordinate value (Y1) of the left upper end A are inserted into the ‘operand[0]’ and the ‘operand[1]’, respectively, a width (W) is inserted into the ‘operand[2]’, and a height (H) is inserted into the ‘operand[3]’, thereby displaying the image.

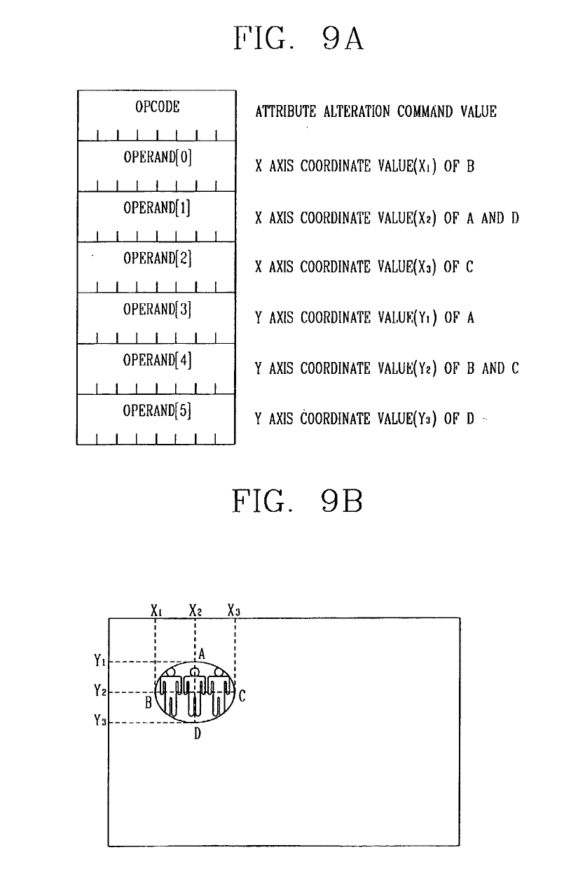

Also, as shown in FIGS. 9A and 9B, it is also possible to display an image on the screen as an ellipse by inserting a X axis coordinate value (X2) of A and D into the ‘operand[1]’, a X axis coordinate value (X3) of C to the ‘operand[2]’, a Y axis coordinate value (Y1) of A into the ‘operand[3]’, a Y axis coordinate value (Y2) of B and C into the ‘operand[4]’, and a Y axis coordinate value (Y3) of D into the ‘operand[5]’.

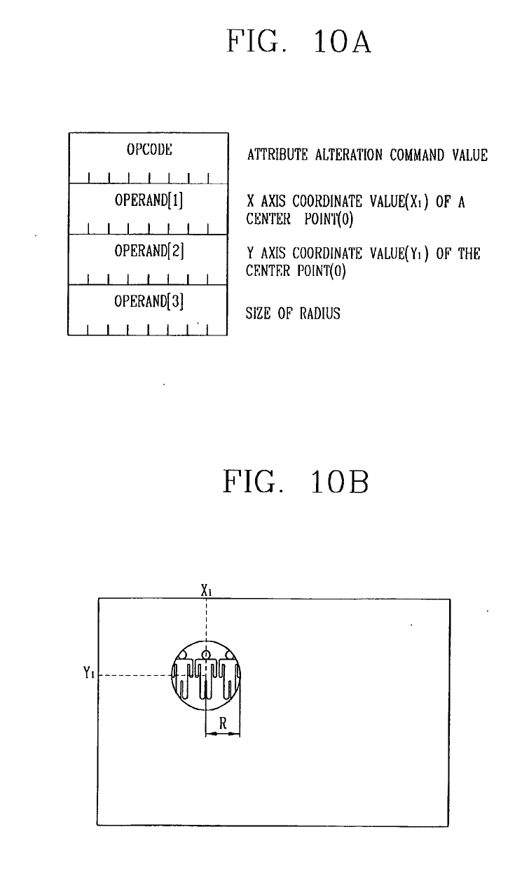

Also, as shown in FIGS. 10A and 10B, it is also possible to display an image on the screen as a circle by inserting a X axis coordinate value (X1) of a center point A into the ‘operand[0]’, a Y axis coordinate value (Y1) of the center point A into the ‘operand[1]’, a radius (R) to the ‘operand[2]’. Like this, the digital image display device 210 can control the display attribute of the image displayed on the screen variously.

In the meantime, many kinds of the attribute information for altering the display attribute of the data stream are selectively used and displayed according is to kinds of the data stream. In the preferred embodiment, it is preferable that an attribute division label for dividing kinds of the attribute information to display the data stream is inserted to the AV/C command frame.

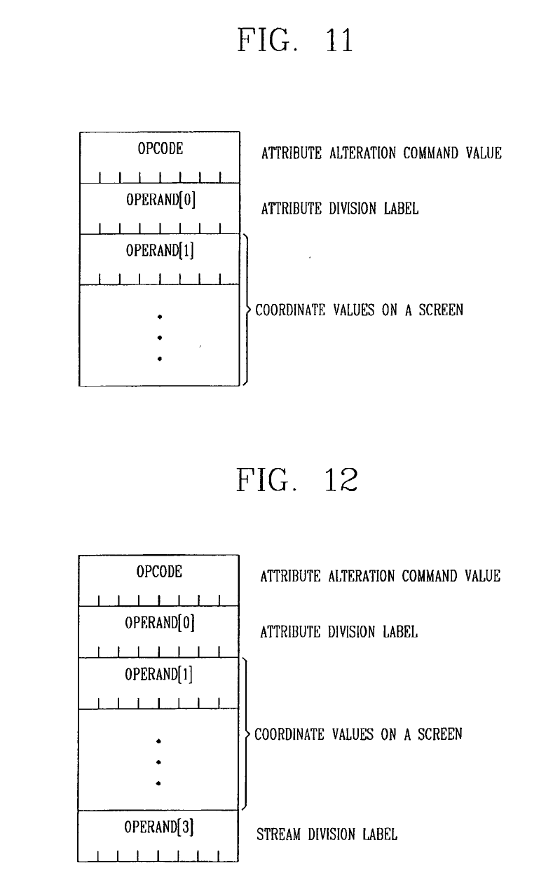

To this end, in case that the image output control unit 203 of the image output device 200 generates the AV/C command frame, for example, as shown in FIG. 11, the attribute division label for dividing the display attribute of the data stream is inserted to the ‘operand[0]’, that is, the next position of the ‘opcode’, and attribute information according to an attribute alteration label is inserted to the next position of the ‘operand[1]’.

Like this, when the attribute alteration label is inserted to the AV/C command frame, the image display control unit 215 of the digital image display device 210 determines kinds of the attribute information by the attribute alteration label in the AV/C command frame, controls the VDP 213 according to a kind of the determined attribute information and the attribute information of the ‘operand[0]˜operand[n]’, and displays an image of the data stream on the screen as a desired size, a height, and a shape of a window.

Also, in case that there are plural data streams having attributes to be altered among data streams to be displayed on the screen, the plural data streams have to be divided.

To this end, as shown in FIG. 12, in case that the image output control unit 203 generates the AV/C command frame, the attribute division label and the attribute information are sequentially inserted to the next position of the ‘opcode’, that is, the ‘operand[0]˜operand[n]’ and a stream division label for dividing plural data streams is inserted to the last position.

Like this, when the stream division label is inserted to the AV/C command frame, the image display control unit 215 of the digital image display device 210 divides the data stream by the stream division label in the AV/C command frame and alters the display attribute of the divided data stream precisely, thereby displaying on the screen.

Also, in said preferred embodiments, even though the location of an image displayed on the screen, the size, and the shape of a window are simultaneously explained, each control is also possible. That is, by altering only the location of the image without altering the size of the image and the shape of the window, only the location of the image can be controlled.

It will be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

That is, even though the present invention was explained with an example of the interface technique, the present invention is not limited to this but can be simply applied with various techniques such as a cable interface technique which transmits a large quantity of capacity information fast to devices like a universal serial bus (USB), power line communication (PLC), a wireless interface technique like a wireless Local Area Network (LAN), radio frequency (RF), and etc.

Also, the present invention can be applied in cases which other command frame and other response frame besides the aforementioned AV/C command frame and the AV/C response frame are used.

As aforementioned, in the processing method for attribute information of a data stream and the apparatus thereof, the size of the image displayed on the screen, the location, and the shape of the window can be controlled by altering attributes of the data stream transmitted from the digital image output device to the digital image display device and displayed by the digital image output device, thereby preventing the image from being overlapped one another.

Also, in the present invention, a replay screen of the digital image display device can be variously controlled by an intention of a transmittance side at the time of data sending, if necessary.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A processing method for attribute information of a data stream comprising the steps of:
determining whether a display attribute of a data stream requires an alteration or not;
generating a command frame having attribute information of a display attribute to be altered, if the display attribute requires the alteration; and
transmitting the data stream and the command frame through a transmittance means.

2. The method of claim 1, wherein the attribute information includes a location of an image displayed on a screen, a size, and a shape of a window.

3. The method of claim 1, wherein the command frame includes an attribute alteration command value and coordinate values of an image display region.

4. The method of claim 3, wherein the attribute alteration command value is inserted into ‘opcode’ of the command frame.

5. The method of claim 3, wherein the coordinate values of the image display region including X axis coordinate values and Y axis coordinate values of a left upper end and X axis coordinate values and Y axis coordinate values of a right lower end are respectively inserted into ‘operand[0]˜operand[n]’ of the command frame so as to display an image of the data stream as a square.

6. The method of claim 3, wherein the coordinate values of the image display region including X axis coordinate values and Y axis coordinate values of a left upper end, a width, and a height are respectively inserted into ‘operand [0]˜operand[n]’ of the command frame so as to display an image of the data stream as a square.

7. The method of claim 3, wherein the coordinate values of the image display region including X axis coordinate values and Y axis coordinate values which meet with a long axis and a short axis of an ellipse, respectively, are inserted into ‘operand[0]˜operand[n]’ of the command frame so as to display an image of the data stream as an ellipse.

8. The method of claim 3, wherein the coordinate values of the image display region including a center coordinate value and a radius of a circle are respectively inserted into ‘operand[0]˜operand[n]’ of the command frame so as to display an image of the data stream as a circle.

9. The method of claim 1, wherein the command frame further includes:
an attribute division label for dividing kinds of attributes which display the image; and
a stream division label for dividing data streams having attributes to be altered.

10. A processing method for attribute information of a data stream comprising the steps of:
receiving a predetermined data stream and a command frame;
determining attribute information of the data stream by the received command frame; and
altering display attribute of the data stream by the determined attribute information, thereby displaying the data stream on a screen.

11. A processing apparatus for attribute information of a data stream comprising:
a data stream output unit for generating a data stream of an image to be displayed on a screen; and
an image output control unit for controlling a generation of the data stream from the data stream output unit and generating a command frame having attribute information by which display attribute of the data stream is altered.

12. The apparatus of claim 11, wherein the attribute information includes a location of an image to be displayed on a screen, a size, and a shape of a window.

13. The apparatus of claim 11, wherein the command frame includes an attribute alteration command value and coordinate values of an image display region.

14. The apparatus of claim 13, wherein the attribute alteration command value is inserted into ‘opcode’ of the command frame.

15. The apparatus of claim 13, wherein the coordinate values of the image display region including X axis coordinate values and Y axis coordinate values of a left upper end and X axis coordinate values and Y axis coordinate values of a right lower end are respectively inserted into ‘operand[0]˜operand[n]’ of the command frame so as to display an image of the data stream as a square.

16. The apparatus of claim 13, wherein the coordinate values of the image display region including X axis coordinate values and Y axis coordinate values of a left upper end, a width, and a height are respectively inserted into ‘operand[0]˜operand[n]’ of the command frame so as to display an image of the data stream as a square.

17. The apparatus of claim 13, wherein the coordinate values of the image display region including X axis coordinate values and Y axis coordinate values which meet with a long axis and a short axis of an ellipse, respectively, are inserted into ‘operand[0]˜operand[n]’ of the command frame so as to display an image of the data stream as an ellipse.

18. The apparatus of claim 13, wherein the coordinate values of the image display region including a center coordinate value and a radius of a circle are respectively inserted into ‘operand[0]˜operand[n]’ of the command frame so as to display an image of the data stream as a circle.

19. The apparatus of claim 11, wherein the command frame further includes:
an attribute division label for dividing kinds of attributes of the image; and
a stream division label for dividing data streams having attributes to be altered.

20. A processing apparatus for attribute information of a data stream comprising:
a receiving unit for receiving a predetermined data stream and a command frame;
a video display processor (VDP) for processing the data stream received by the receiving unit and outputting, thereby displaying on a screen; and
a control unit for altering a size of an image displayed on the screen, a location, and a shape of a window according to the command frame.
